(19) United States
(12) Patent Application Publication
(10) Pub. No.: US 2008/0206723 A1
(43) Pub. Date: Aug. 28, 2008

(54) Baseball System and Apparatus for Signal Calling

(76) Inventor: Steven Hunter, Springville, AL (US)

Correspondence Address: DEXTER L. MCFARLIN;MASSEY, STOTSER, AND NICHOLS, P.C., P.O. BOX 94308, BIRMINGHAM, AL, 35220, US

(21) Appl. No.: 11/949,040

(22) Filed: Dec. 2, 2007

Related U.S. Application Data
(60) Provisional application No. 60/891,884, filed on Feb. 27, 2007.

(51) Int. Cl. G09B 19/00

(52) U.S. Cl. 434/156

(57) ABSTRACT

A system and apparatus for signals, signs, and plays to be communicated to the baseball/softball players using a series of band cards worn by the players that contain a unique and varying combination of numbers, letters, and symbols. With or without the designation of a “hot color” or symbol, which dictates which column the players are supposed to refer to for their plays and assignments, the coach is able to signal both real and fake signals and plays by following the hot or cold designation with certain numbers and letters. These numbers and colors can be coordinated for each position on the baseball/softball field such that the same “hot color” and series of numbers puts all the players in their individual desired position. These band cards can be worn in several places, including in wristbands with clear plastic windows or attached to baseball hats.

### CROSS REFERENCE

Claims the benefit of Provisional Patent Application No. 60/891,884, Feb. 27, 2007.

### FEDERAL FUNDING

N/A

### BACKGROUND

This invention relates to a baseball/softball signal calling method and apparatus for sending and receiving signals and calls from a coach to player(s) during a game of baseball and/or softball.

Baseball, as can earliest be linked to its present form, was first played as early as 1845 in the United States. There is some debate as to the exact origins of the current American baseball, however it is undisputed that it has been played in some form for over 150-years. Since that time, owners, coaches, and players have sought to achieve some advantage over the opposing teams. This quest has led to many endeavors, including corked bats, ball gloves, baseball bats, and signal calling. Signal calling is a way that a coach can lead his team by “signaling” his team directions. Many harken to their youth when their third base coach making a series of strange hand and arm signals that had to be memorized. The coach would typically pull on an ear lob, rub their bicep, and tug on the visor on their ball cap to signal a certain play, or some variation of the same. While the secrecy was entertaining at first, the signal sequences became difficult to follow and bordered on distracting as time went on. This memory is basically the same version, in some form or fashion, used by all levels of baseball currently.

Prior art attempts at baseball signal calling used this same series of hand and arm signals for a coach to dictate the plays, positions, or pitches for the players to follow. The signals usually involved a series of movements that became difficult to differentiate between active and dummy signal calling. It is also difficult to discern the exact play desired as the movements become more complex.

While there were communication issues that arose between coach and player, there was also a danger that developed from the opposite team. As this signal calling developed, other teams began stealing the signals in an attempt to know what their opposition was planning. Thus, once you called a play, after the other team intercepted the signal, every ensuing time you called the play the other team knew the play you had called. This led to the signal calling becoming more complex with active and dummy sequences. Active signals were “hot” and meant you were supposed to do what was signaled. Dummy signals were “cold” and meant to mislead the opposition. Hence, there has developed a need to mask your signals to avoid interception while still remaining simple enough to be understandable and non-distracting to your own players.

What is needed is an interception proof, non duplicative baseball signal calling method and apparatus that allows a coach to signal or call in specific plays, positions, and pitches without the fear that the signals or calls have been intercepted or recognized by an antagonist.

### SUMMARY

The present invention is a baseball/softball system and apparatus for signs and signaling, which allows a coach to make play calls more effectively, with less confusion to the players about what they are to do, and with immunity as it is virtually impossible to intercept the signals and understand what is being called. The band cards, named because the cards are usually attached to the player's wristband, have cards for both offense and defense for each position on the baseball team. The band cards have differently colored columns breaking out in each column different actions for the players to make depending on a numeric code. The coach will designate a “hot color” when the players are in the dugout before they take the field. This “hot color” corresponds with the column the players are supposed to look to for their plays. If the coach starts the play calling by saying or signaling the “hot color,” then the player knows that the subsequent numeric sequence dictates the play they are supposed to perform. Likewise, the coach can call out decoys by calling out plays using colors other than the “hot color.” By looking up the plays and pitches on a band card based on a series of numbers provided by the coach, the players are able to know exactly what the coach is asking them to do. The series of numbers is usually five or below, so that it corresponds with one hand.

The same play also might have five different sets of numbers. For example, the coach designates “Blue” as the hot color. He would then call out “BLUE 151” to his players. They would look on their cards for the blue column, and then for the number 151. This corresponds with a play or pitch on the band card. There are several sets of numbers that call for the same play or pitch. Each series of numbers is unique and not repeated. Many cards can be used with different variations so that no series of numbers is repeated in a game.

By using this system, a baseball player then knows what the coach is asking him to do without having to watch an entire sequence of body movements. The method currently used in baseball involves multiple body signals that are difficult to interpret as it can be very complicated, for instance, tugging on your ear, them wiping the brim of your hat, and rubbing your right thigh indicates that the next sequence of body language is what the player is supposed to perform. Not only is it complicated, but it is difficult to change the signals up in the middle of the game. It is also easy for the opposing team to pick up on the signals and know what play or pitch has been called. This new invention is virtually impossible to steal the signals due to the unique band cards, and these cards allow the team to change their signals every few innings. Due to having a ready reference, it also allows for more complicated calls to be made.

There are several cards in the system that correspond with the position played and whether the player is on offense or defense. The cards can be made of various media capable of being written or printed on. This is usually done on paper, cardboard, or plastic and can be laminated with a plastic film. The cards are divided into columns and rows, distinguished with different colors, symbols, numbers, and actions to be performed by that player. The cards are attached by various means to the player, whether on a wristband, under the brim of their hat, attached around their neck, or kept in their pants, shirt, or socks. Since these cards are divided into differently colored columns or bands, and typically worn on a baseball player's wristband, they are typically referred to herein as “band cards.” Someone, usually the coach or assistant coach, will call a “hot” color or symbol before the players take the field, which indicates to the players which row or column they are to use for that particular inning or game. The coach is then able to communicate, whether verbally or visually, with signaling cards, physical actions of the body, writing on a dry erase or chalk board, to the players a pitch, location, or play by calling out the color, symbol and/or a series of numbers. This will correspond with a location on the card, which in turn corresponds with a word, acronym, or symbol, that indicates the action to be performed by the player in that given situation. On the cards, the actions to be performed by the player are listed in random and sometimes repetitive order in the row or column. This way, someone can call for a particular play, pitch, or action several times without using the same signal twice. There are several cards with unique plays, signs and signals so that the cards can be rotated at will, making it very difficult for the opposing team to learn the team's signals and anticipate their actions. The coach is thus able to communicate his desired plays, signs, and signals to the players according to the system, almost eliminating the ability of the opposing team to steal the signals and eliminating the possibility of a player missing a signal. The opposing team can see the signals being communicated, and without the benefit of the cards and the “hot” color or symbols, are unable to anticipate the action of the team using this invention. It also simplifies the plays, signs, and signals in such a manner that players on the team using this invention understand exactly what they are being asked to perform by consulting the card and the appropriate row or column.

### DRAWINGS

FIG. 1 is a top view of a pitcher's band card (pitching and playing defense) of the present invention;

FIG. 2 is a top view of the pitcher's band card (pitching and playing defense) of the present invention illustrating a simplified version with a different combination of numbers, signals, and symbols;

FIG. 3 is a top view of the short stop's or any position's band card (playing defense) of the present invention illustrating the numbers, signals, symbols, position, action, and plays for the shortstop;

FIG. 4 is a top view of the second baseman's or any position's band card (playing defense) of the present invention the numbers, signals, symbols, position, action, and plays for the second baseman;

FIG. 5 is a top view of the third baseman's or any position's band card (playing defense) of the present invention the numbers, signals, symbols, position, action, and plays for the second baseman;

FIG. 6 is a top view of the first baseman's or any position's band card (playing defense) of the present invention illustrating the numbers, signals, symbols, position, action, and plays for the third baseman;

FIG. 7 is a top view of the catcher's or any position's band card (playing defense) of the present invention illustrating the numbers, signals, symbols, position, action, and plays for the first baseman;

FIG. 8 and FIG. 9 are top views of the card for a player(s) (playing offense or batting) of the present invention illustrating the numbers, signals, symbols, position, action, and plays for a player at bat or as a runner on base;

FIGS. 10 & 11 are perspective views of the card for a player(s) on a athletic wrist band with flap and two clear plastic pouches for viewing the band cards on the player's wrist.

FIG. 12 is a bottom view of a baseball hat with the band card attached to the underside of the hat's bill.

FIG. 13 is a side view of a athletic wristband with two pouches/windows on the wrist of a baseball player.

FIG. 14 is a top view of an alternative pitcher's band card of the present invention illustrating a different method of arranging the band card with more sequential numbers.

FIG. 15 is a top view of an alternative offensive band card of the present invention illustrating a different method of arranging the band card with more sequential numbers.

### DESCRIPTION

### Detailed Description of the Invention

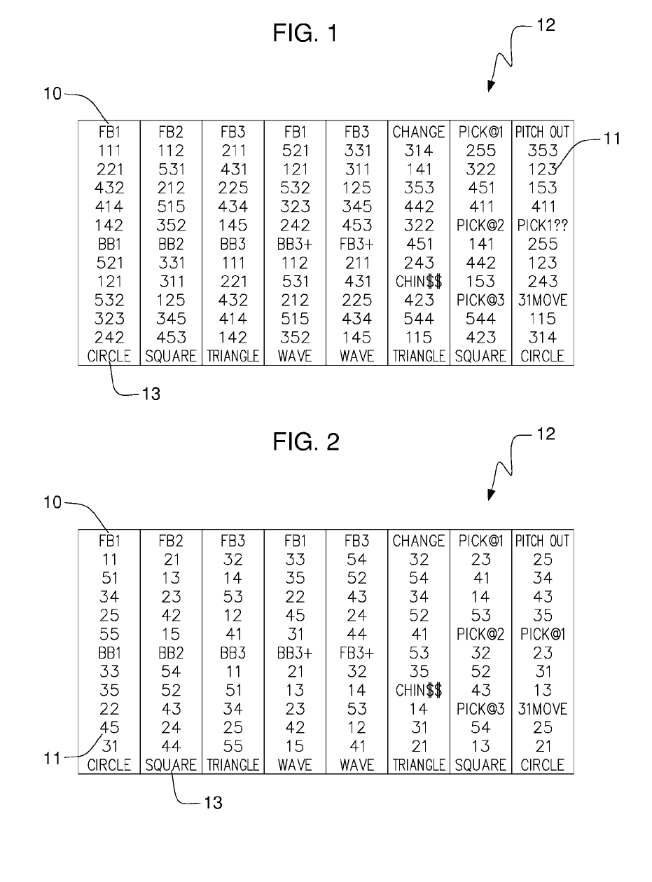

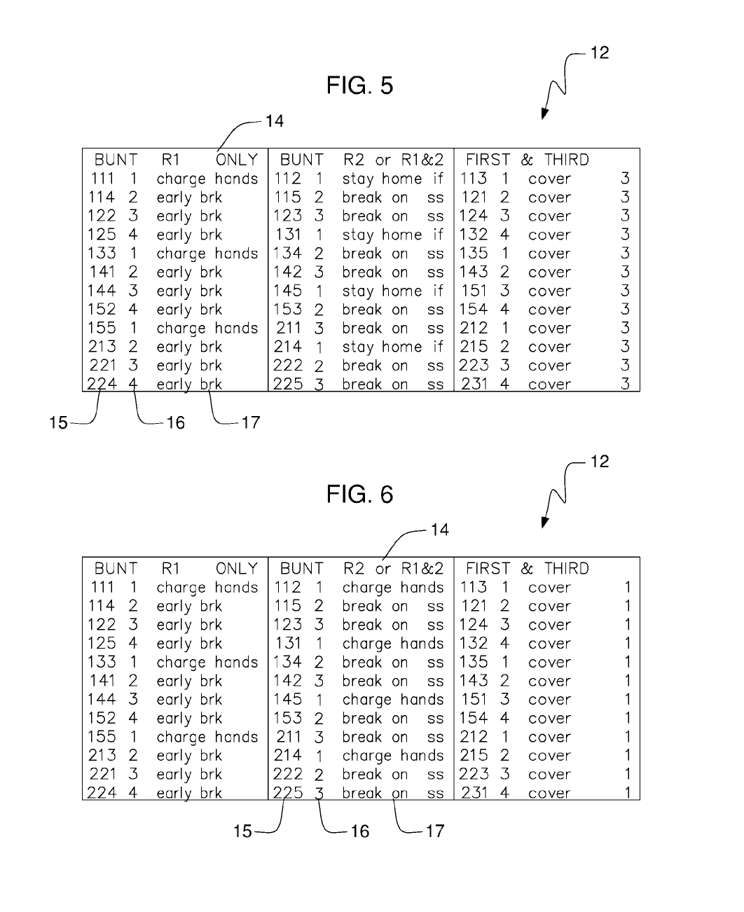

Referring now to the invention in more detail, in FIG. 1 to FIG. 13, there are shown band cards having a first side with multiple and varying columns and rows. The columns and rows contain a coded system that allows a coach or person to communicate signs, signals, pitches and plays to the players on a baseball team. The columns can be colored alternating colors or titled with unique headings or a combination of both.

The present invention is an apparatus and method of calling baseball plays signs and signals. This invention can be easily modified to fit the level and experience of the players or team in question. There are several band cards in the system that correspond with the position played and whether the player is on offense or defense.

The band cards are usually made on typing or copying paper using a computer and color printer. It is possible to make them using a typewriter or pen and pencil. The band cards or cards can be made of various media capable of being written or printed on. This is usually done on paper, cardboard, or plastic and can be laminated with a plastic film. The cards are divided into columns and rows, distinguished with different colors, symbols, numbers, and actions to be performed by that player.

The cards are attached by various means to the player, whether on a wristband, under the brim of their hat, attached around their neck with a rope, cord, or chain, or kept in their pants, shirt, or socks. Someone, usually the coach or assistant coach, will call a “hot” color or symbol before the players take the field, which indicates to the players which row or column they are to use for that particular inning or game. The coach is then able to communicate, whether verbally or visually, with signaling cards, physical actions of the body, writing on a dry erase or chalk board, to the players a pitch, location, or play by calling out the color, symbol and/or a series of numbers. This will correspond with a location on the card, which in turn corresponds with a word, acronym, or symbol, that indicates the action to be performed by the player in that given situation. On the cards, the actions to be performed by the player are listed in random and sometimes repetitive order in the row or column. This way, someone can call for a particular play, pitch, or action several times without using the same signal twice. There are several cards with unique plays, signs and signals so that the cards can be rotated at will, making it very difficult for the opposing team to learn the team's signals and anticipate their actions. The coach is thus able to communicate his desired plays, signs, and signals to the players according to the system, almost eliminating the ability of the opposing team to steal the signals and eliminating the possibility of a player missing a signal. The opposing team can see the signals being communicated, and without the benefit of the cards and the “hot” color or symbols, are unable to anticipate the action of the team using this invention. It also simplifies the plays, signs, and signals in such a manner that players on the team using this invention understand exactly what they are being asked to perform by consulting the card and the appropriate row or column. The historical method of calling baseball plays, signs, and signals involved a series of hand and body gestures, which the player had to memorize, see, recognize, interpret, and perform. This old method was prone to mistakes, confusion, and the opposing team could sometimes figure out the signals, causing them to know what the coaches were calling for their team to do.

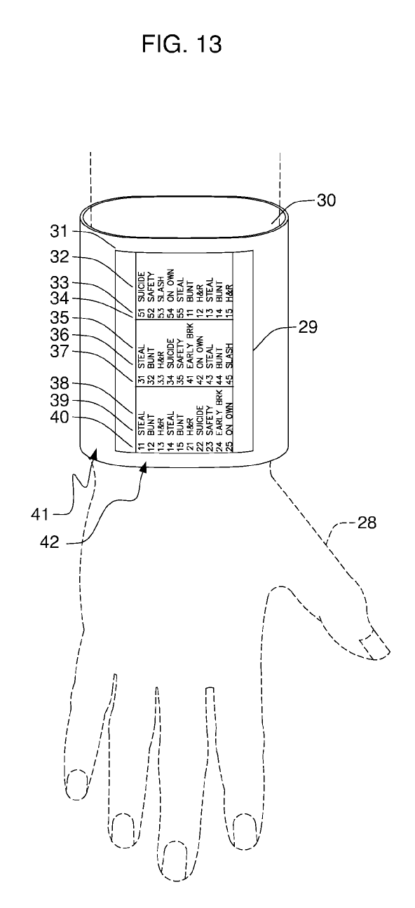

FIG. 1 is a band card related to the pitching duties in baseball. In FIG. 1, component 10 there is shown a heading to differently colored columns. The heading involves a code or acronym for the pitch or plays that the person making the signs and signals desires. A “hot color” or symbol is indicated to the players before they take the field. If the person making the call does not begin the sign or signal with the “hot color,” then the sign or signal is a fake signal and not to be followed. If the “hot color” is signed or signaled, either verbally or by body language, it is followed with a sequence of numbers. Normally, these numbers are a series of numbers below five, but they can range from zero to ten. The reason for the numbers typically being five or below is so that the sign or signal can be accomplished via body language with a single hand. FIG. 1, component 11 shows a number sequence. FIG. 1, component 12 is the band card, which can be made of any durable substance, such as paper, cardboard, plastic, and vinyl. It can also be laminated for water resistance and durability. FIG. 13, component 13, is the symbol that can be used to indicate which column to utilize as the “hot color” or symbol so that players known which column to utilize for their plays.

FIG. 2 is another band card related to the pitching duties in baseball. In FIG. 2, component 10 is a heading to differently colored columns that relate to the play or pitch called. For example, “FB1” is short hand for fast ball in zone 1. FIG. 2, component 11 is a series of numbers that signals the exact play or pitch to be performed. FIG. 2, component 12 is the band card itself, which can be made of any media capable of showing the letters and numbers shown. FIG. 2, component 13 is the symbol that can be utilized to designate the “hot color”, column, or symbol, verbally or with body language.

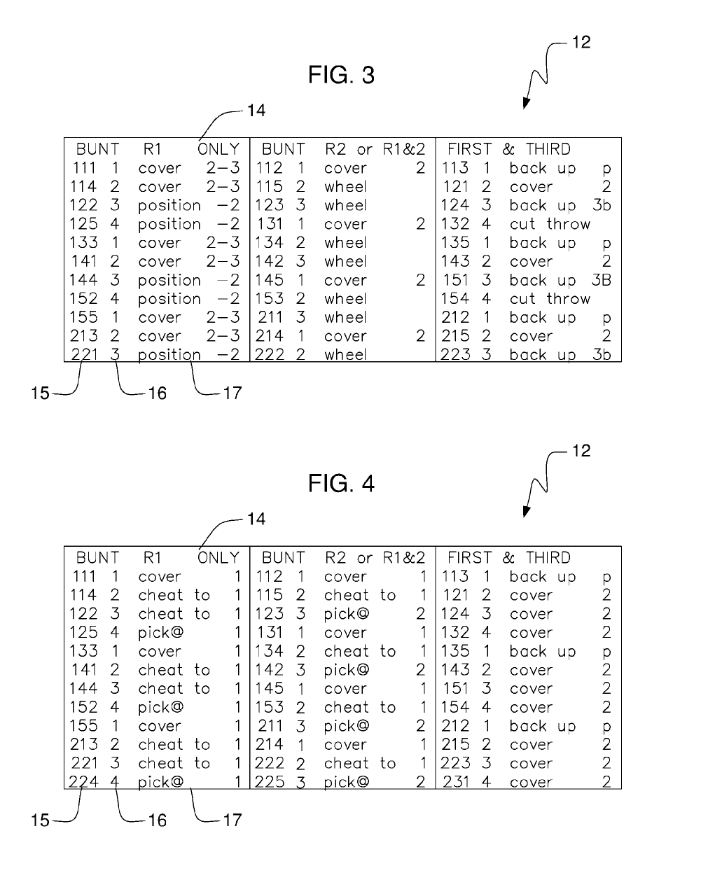

FIG. 3 to FIG. 7 are band cards for field players that relate to the defensive duties of baseball players. FIG. 3 is a card that can be utilized by a shortstop for his defensive plays and duties. These band cards can be modified for any position and are optimally re-arranged in different sequences. This allows the cards to be rotated throughout the game such that calling the exact same “hot color” and number will result in different plays being called depending on the version of the band card the player is referring. FIG. 3, component 12 is the band card itself, which can be made of any media capable of showing the letters and numbers. FIG. 3, component 14 is a short hand way of referring to the defensive situation as it relates to the runners and hitter. For example, “BUNT R1 ONLY” is shorthand for when the hitter will bunt and/or there is a runner on 1^{st} base. FIG. 3, component 15 are the numbers calling for the particular defensive position or play. This is normally three digits, with each number five or below. FIG. 3, component 16 is a number which is the shortened version of component 15. This allows the coach even more flexibility in changing the play calling by changing the number of digits used to sign and signal the plays. FIG. 3, component 17 is the position or play that is being asked of the baseball players to perform. For example, if there was a runner on first and coached signaled or called “125”, then the player is being asked to “position −2” or position themselves at or near second base.

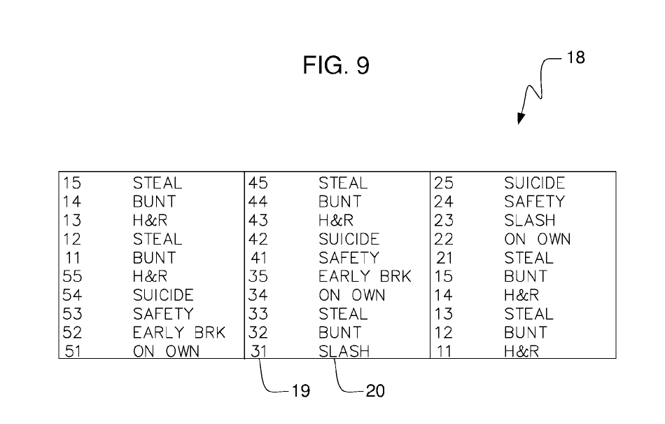

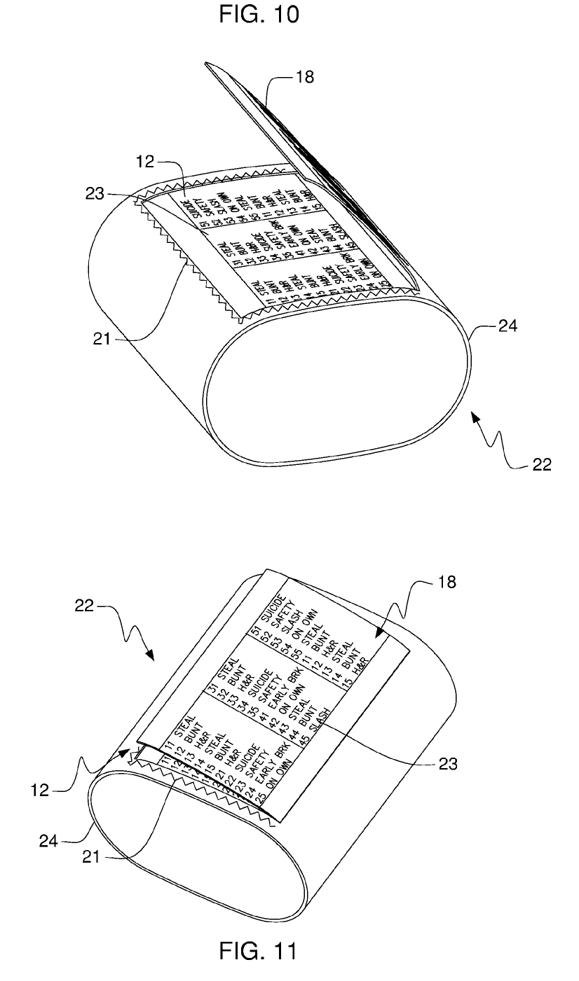

FIG. 8 to FIG. 9 are band cards for players that are at the plate and runner(s) on base, and generally related to the offensive portion of baseball. FIG. 8, component 18, and FIG. 9, component 18, are the band card itself, which can be made of various media capable of displaying the required numbers, letters, and different colors for the columns. Typically, the band card has the column colored alternating colors. However, it is possible to place a title at the top of each column designating a color, symbol, or word. FIG. 8 and FIG. 9, component 19 is the number, which indicates the play or action the person making the sign or signal, desires. For example, in FIG. 8, component 19, from the first column which is normally colored, signaling that color plus “55” would tell a batter at the plate to “H&R”, which is short hand for “hit and run.”

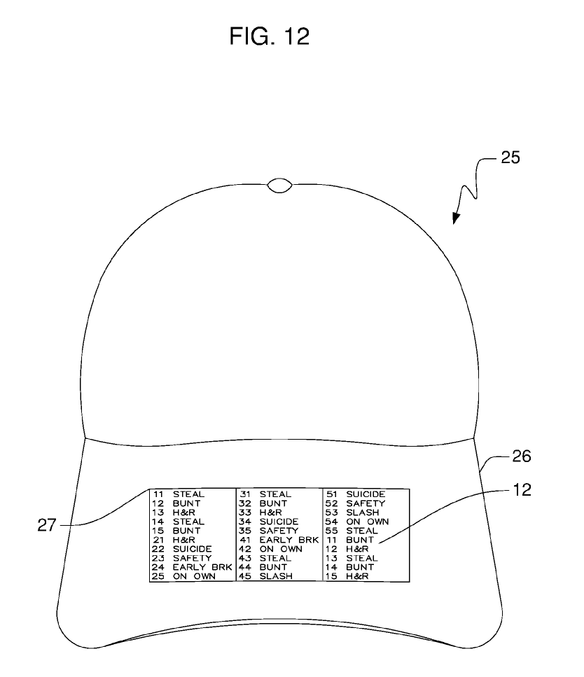

Referring now to the invention in more detail, in FIG. 10 and FIG. 11, there are shown two athletic wrist bands that house the band cards in two clear plastic pouches/windows so that the baseball players can utilize and see the band cards while they are also able to exert themselves physically.

FIG. 10, FIG. 11, and FIG. 13 are the preferred method for a player to carry these band cards. FIG. 10 is an athletic wrist band made out of elastic, stretching material, with a velcroable flap that both has as clear plastic pouch and window facing outwards and covers a clear plastic pouch and window on the inside covered by the flap. The flap is secured by being stitched on one side to the wristband and the other three sides having Velcro to secure it. This way, the flap will not flap and will remain functionally synonymous with the wristband when the baseball player begins playing. FIG. 10, component 12 shows the band card placed inside the inner pouch such that the letters and numbers on the band card are legible and visible through the clear plastic window. FIG. 10 and FIG. 11, component 24 is the athletic wristband made of an elastic and stretchable material. FIG. 10 and FIG. 11, component 18 is the offensive band card inserted into the outer clear plastic pouch such that the letters and numbers on the band card are legible and visible through the clear plastic window. The band cards in the outer pouch can be the offensive band card or the defensive band card. The band card in the inner pouch can be either the offensive band card or the defensive band card. FIG. 10 and FIG. 11, component 21 is a Velcro strip that goes around the clear plastic window and on the underside of the flap, making it possible to open and close the flap, but allowing it to remain closed when the baseball player is athletically active. FIG. 10 and FIG. 11, component 22 is the entire athletic wristband with the band cards inserted into the clear plastic pouches. FIG. 10 and FIG. 11, component 23, is the clear plastic that creates the transparent portion of the pouch, if not the entire pouch. This allows the players to slide different band cards in and out of the pouches, thus allowing for different signs and signals, but allowing them to refer to the plays on their wrist with minimal extraneous movement during the course of baseball play.

In FIG. 12, there is shown a baseball hat that can be used to hold the band cards so that the baseball players can utilize and see the band cards while they are also able to exert themselves physically. FIG. 12, component 12 is a band card attached by various means to the underside of a baseball hat's brim. FIG. 12, component 25 is a baseball hat looking at the hat from the underside up. FIG. 12, component 26 is the underside of the brim of the baseball hat. FIG. 12, component 27 is the means to attach the band card to the brim of the hat such that it will not become detached from the brim during physical activity. Normally, this is done by a means where the band card can be detached and reattached repeatedly. This can be done with Velcro on the underside of the brim and to the back of the band card.

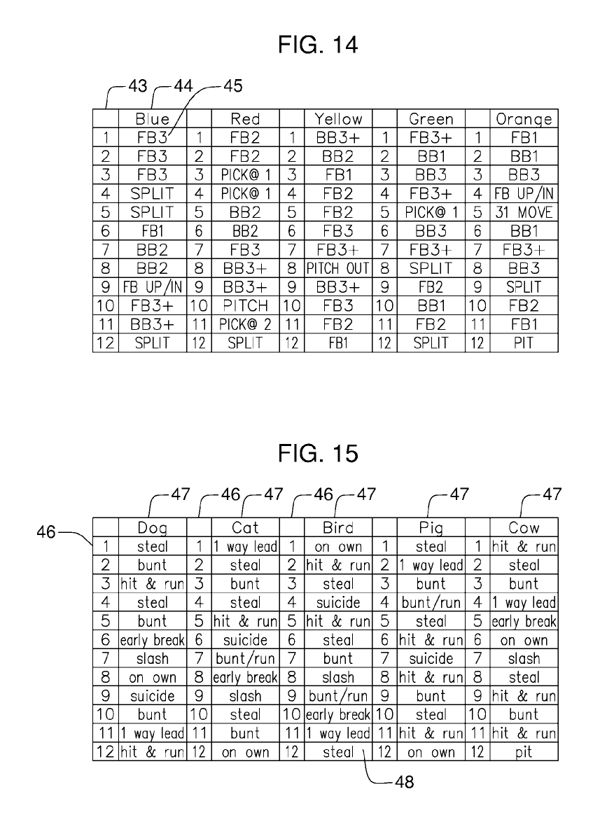

In FIG. 14 and FIG. 15, there are shown another possible version of the present invention's band cards. FIG. 14 is an example of a pitcher's (and catchers as he must known what is being thrown) band card with a simplified and sequential numbering and block outlining. FIG. 15 is similar to FIG. 14 but a offensive band card for players batting and running and trying to score runs. This is just another example of a way to arrange the band cards can be used on a defensive band card where the players use the band cards to try and get the other team out. These band cards outline the outside of the individual blocks with a thin black line to separate them. There are still multiple colored columns with the heading at the top of each column represented by a color, word or symbol. The rows are arranged by sequential numbers. Each number corresponds to a different pitch or pitcher's play or offensive action.

In more detail, still referring to the invention of FIG. 1 to FIG. 2, this is a catcher or pitcher band card that illustrates several different calls, signs, and signals that can be made by the coach to those players. In FIG. 1, there are eight colored columns, which also have a designated shape and number to communicate a pitch, location, or specific play. Using FIG. 1, if the third column was green and that was the designated “hot color,” the coach could call out or signal “GREEN 211.” This would let the pitcher and catcher would know the coach has called for “FB 3” in the third column, which is green and the first number is “211.” “FB 3” stands for a “fast ball (FB) in zone 3.” Alternatively, the coach could call or signal a “SQUARE 141.” The pitcher and catcher would look under the SQUARE column for “141.” This would correspond with the coach calling for a “PICK @ 2.” Notice, there are two “SQUARE” columns, however, there is only one number “141.” In addition, the numbers are limited to those you could use one hand to signal by holding up fingers and thumbs. For more experienced players and teams, it is possible to include higher numbers to increase the number of numbers, plays, signs, and signals available. The signs or signals can be given with hands and body language or verbal depending on the environment or specific need.

After so many innings, it is preferred to exchange the band cards with new ones with different combinations in the placement of the numbers, colors, plays, or symbols. The coach also has the option of increasing the numbers and symbols that correspond with each sign, signal, pitch, or play. See FIG. 3 for a band card with fewer numbers for each pitch and play.

The construction details of the band card apparatus and method invention as shown in FIG. 1 to FIG. 13 are each made of common typing or copier paper, but they can be made from any sufficiently solid material, such as cardboard or plastic. The band cards are each about two and a half inches tall by five inches wide as shown. However, this can vary by several inches and must be sufficiently large to display legible numbers, symbols, and colors. The band card must also be sufficiently small enough to be utilized by the players and coaches during the game of baseball itself.

The advantages of the present invention include, without limitation, the ability to communicate effectively in a baseball environment signs and signals. This invention can be easily modified to fit the level and experience of the players or team in question. This invention will totally eliminate another team's ability to steal your signals and will greatly reduce the chances of a missed sign. Even if the other team is able to pick up on your signs and signals, they alternate and vary to such a degree that is unlikely to be of use. For example, FIG. 3, under the first column “BUNT R1 ONLY” which we will say is blue, the number combinations of “111,” “114,” “133,” “141,” “155,” and “213” all call for the same play, which is “cover 2-3” if blue is the designated “hot color.” “cover 2-3” stands for covering the space between second and third base. If the first column is colored blue, the second green, and the third yellow, then one time the coach can signal “BLUE 111.” The next time “BLUE 141.” The next time he can call “YELLOW 151” and “BLUE 213.” “YELLOW 151” is a fake call and the players are not to obey it as it is not preceded by the designated “hot color.” This way, the coach has called for the exact same play, to “cover 2-3” three separate times, with different number combinations and colors. It is much more difficult to pick up on a pattern in the signs and signals this way. If someone is smart enough to figure out the system, the coach can rotate the band cards with new ones every few innings, making it virtually fruitless for the opposing team to try to decode the system.

In broad embodiment, the present invention is a method and apparatus of any size and shape that allows the players to wear and possess the band cards will still playing the game of baseball and send and receive signs and signals for play calling. These band cards allow the players and coaches to be of the same mind in calling signs and signals during the game. These band cards can be utilized by the players and coaches in a variety of ways and as allowed by the rules of baseball. There is a variety of different ways the player can wear or carry the band cards. Players can wear the cards in a wristband that has a clear window allowing the player to see the band card while still being able to physically exert themselves during the game. The players can wear the band cards in a clear container attached around their neck via a rope or chain. The players can stick the band cards in their pockets, socks, or inside their baseball gloves.

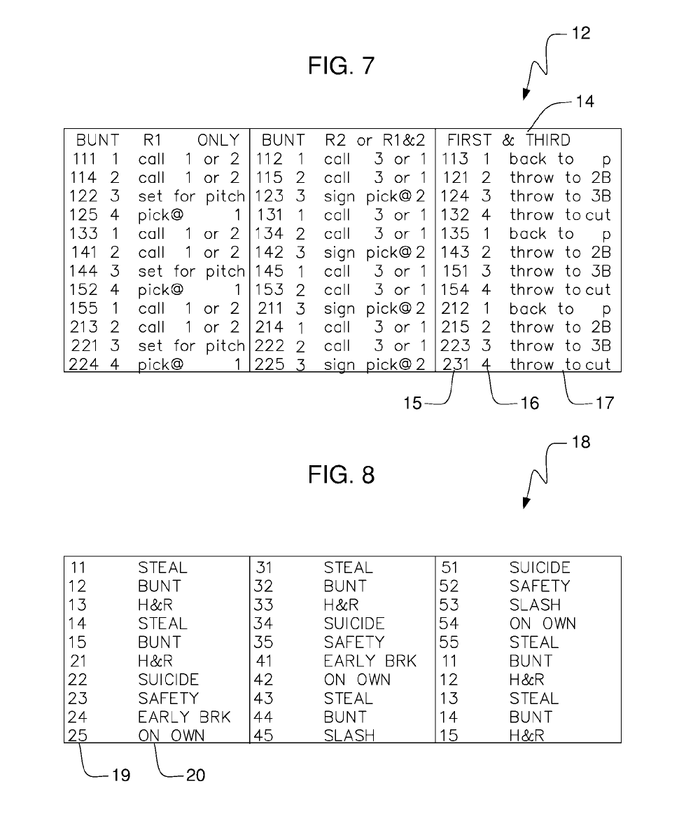

In more detail, referring to the invention of FIG. 3 to FIG. 7, these are defensive band cards for the players other than the for the pitching and catching itself in baseball that illustrate several different calls, signs, and signals that can be made by the coach to those players. The invention in FIG. 7 illustrates a band card for the defensive play calling for the catcher other than the pitch signal called. In FIG. 3 to FIG. 9, there are three colored or uncolored columns, of different colors, which also have a designated shape and number to communicate a pitch, location, or specific play. There can be one column or as many as can be fit in the space while still being legible.

The defensive band cards will communicate the proper call in all the desired defensive situations. In FIG. 3 to 7, there are various defenses, which can include bunt defenses and first and third situations. There can be additional scenarios added based on the position of the opposing teams runners, the score and inning. There is less of a concern for deception with these defensive band cards as the individual positions and assignments are more of a concern. A color and number call is made and each player has his own responsibility listed on the band card. It is usual to eliminate confusion by posting the call, sign, signal, or play in a visible location in the dug out. The coach writes a colored number on a dry erase board or similar apparatus, or hangs a colored tile or flag with numbered tiles on a specially designed pole.

Using FIG. 4, and assuming the first column is colored blue and also the designated “hot color”, the coach could call out or signal “BLUE 114” and the second baseman would check his band card for the corresponding row in the blue column under “BUNT R1 ONLY.” “BUNT R1 ONLY” stands for a bunt defense called when there is a runner (“R”) on first base (“1”). In this instance, “BLUE 114” would correspond with the second baseman's defensive play to be to “cheat to 1,” which stands for getting closer to first base than their normal position.

In addition, the numbers are limited to those you could use one hand to signal by holding up fingers and thumbs. For more experienced players and teams, it is possible to include higher numbers to increase the number of numbers, plays, signs, and signals available. The signs or signals can be given with hands and body language or verbal depending on the environment or specific need.

There are separate cards for each position in baseball. There is a defensive band card for the first baseman, second baseman, short stop, third baseman, catcher, pitcher, and the three outfielders. Each band card has unique plays or positions depending on their defensive assignments. For instance, a short stop has different assignments than the first baseman. The right field outfielder has a different defensive assignment than the catcher.

After so many innings, it is preferred to exchange the band cards with new ones with different combinations in the placement of the numbers, colors, plays, or symbols. The coach also has the option of increasing the numbers and symbols that correspond with each sign, signal, pitch, or play. The band cards can also be coordinated so that the same sign or signal puts all of the defensive players in the correct position for that situation. However, the coach can position the players individually or by only changing the position of select players after positioning the whole team.

In more detail, referring to the invention of FIG. 8 to FIG. 9, these are offensive band cards for communicating all signs, signals, and plays from a coach to the hitter and runner or runners. Each band card will typically have three differently colored columns with numbers and specific call in shorthand or abbreviation. There can be more or fewer columns as the coach desires. It is also preferred to exchange the offensive band cards every couple of innings or so, where the numbers, colors, symbols, have been re-arranged. FIG. 8 could be utilized for innings one through five. FIG. 9 could be utilized for innings five through nine. These are merely examples. The same band card can be utilized for an entire game or it can be rotated and exchanged every inning or even every batter. It is a flexible invention that can be modified to fit the team and situation. Signs, signals and plays are given with a color and a number call. These signals may be called by hand and body signals or verbally. There is preferably a “hot” color or symbol called and two decoy colors or symbols. The “hot” color or symbol corresponds with the column or row a player is to utilize for that particular play, sign, or signal. If the coach does not mention the “hot” color, then the sign, signal, or play is merely a decoy and meant to confuse the opposing team. The “hot” color is preferably communicated in the dug out so that the opposing team cannot overhear. It is intended to rotate and change the “hot” colors and thus, change the rows or columns a player is to look to for their play. By using this invention, missed signs and signals can be eliminated.

The offensive band cards will communicate the proper call in all the desired offensive situations. In FIG. 8 to FIG. 9, both hitter and runner situations are covered. There can be additional scenarios added based on the system desired by the coach and team.

In addition, the numbers are normally limited to those you could use one hand to signal by holding up or not holding up fingers and thumbs, or from zero to five. For more experienced players and teams, it is possible to include higher numbers to increase the number of numbers, plays, signs, and signals available. The signs or signals can be given with hands and body language or verbal depending on the environment or specific need.

There are separate cards for each position in baseball. There is a defensive band card for the first baseman, second baseman, short stop, third baseman, catcher, pitcher, and three or more outfielders. Each band card has unique plays or positions depending on their defensive assignments. For instance, a short stop has different assignments than the first baseman. The right field outfielder has a different defensive assignment than the catcher.

After so many innings, it is preferred to exchange the band cards with new ones with different combinations in the placement of the numbers, colors, plays, or symbols. The coach also has the option of increasing the numbers and symbols that correspond with each sign, signal, pitch, or play.

FIG. 13 is an athletic wristband made of an elastic, stretching material, with Velcro holding down a pouch with a clear plastic window over the top of another pouch with a clear plastic window on the wrist of a baseball or softball player at all levels. FIG. 13, component 28 is the wrist and portion of a baseball/softball player's arm. It is shown with a broken line to better show the wristband with the band cards contained in it. FIG. 13, component 29 is the sewing with thread that holds down the one side of the outer pouch, which is placed over an inner pouch with a clear plastic window. The other three sides of the pouch or flap are secured with Velcro. FIG. 13, component 30 is the elastic, stretchable material that is used to make the body of the athletic wristband. FIG. 13, component 31 is the Velcro that is underneath the edges of the outer pouch or flap, as well as on the outer edges of the underlying pouch with a clear plastic window. FIG. 13, components 30 and 31 allow the player to use two cards at the same time. One pouch can contain the offensive band card and the other the defensive band card. The player, if he needs to look at the outer band card, can view it through the clear plastic window on the pouch. If the player needs to look at the card in the band card underneath the outer pouch, he can pull on the outer pouch or flap on the Velcro sides of pouch and open it up along the stitching. At that point, the player can view the band card in the inner pouch through its clear plastic window. Once he is done viewing the band card, he can close the outer pouch or flap using the Velcro. Alternatively, the athletic wristband can have only one pouch and only one clear plastic window so that the player can only use one band card at a time. FIG. 13, component 32 is the play or command the coach is asking the player to perform according to the numeric sequence and “hot color” which designates the column for the player to refer for instructions. FIG. 13, components 33, 37, and 40 are the numeric sequences, which dictate and correspond with the play or command called by the coach or someone else. This is part of the sign and signal called in by the coach and usually follows the “hot color” called out. The numeric sequence can be one number or several. The combinations of numeric sequences are as varied as the imagination of the person making the band cards. Typically, the same commands are repeated under different numeric sequences. This is so the coach can call for the same play, but he will be using different numbers in the same column to make that sign and signal. It depends on the coach, the player, and how complicated they want the signs and signals to get. FIG. 13, components 34, 36, and 39 are the colors of the columns in the band card. The band card is typically divided up into three columns with three different columns for offensive band cards. The pitching band card and defensive band card can add several more columns of different colors. Depending on the play desired by the person calling the plays and which column contains the play desired, the coach will call out the “hot color,” which corresponds with the column, the play and corresponding numeric sequence. This also allows someone to call out fake plays, but calling out colors and numeric sequences that do not begin with the “hot color.” FIG. 13, components 32, 35, 38 are the plays or action the coach wishes the player to make in the second column. The plays are usually abbreviations, shortened words, code words, or acronyms that the team and coach are familiar with using. There are as many variations on this command as the team and coach's imagination. FIG. 13, component 41 is the band card, which is inserted in the pouch or pouches in the athletic wristband. It also corresponds with the clear plastic window, which is transparent enough so that the band card is visible through the plastic. FIG. 13, component 42 is the band card that is in the inner pouch with the clear plastic window. As mentioned above, this inner pouch with the clear plastic window potentially contains a second band card that the baseball player can refer to for the signs and signals called. This allows the players to not have to change cards as often as they have both an offensive and a defensive card on them at the same time. It also allows the players to play the game while keeping the band cards on their person and while being nonrestrictive of their movements.

In more detail, referring to the invention in FIG. 14, is a pitcher's band card with simplified sequential numbers. Component 31 shows the sequential numbers running down the column starting at 1 and going to 12. Component 44 shows the heading of the column, whether it be “Blue,” “Red,” “Yellow,” “Green,” “Orange,” or whatever color, word or symbol the coach desires. In addition, each column can be colored the same color as the heading to make it easier to find. Component 45 shows the abbreviated actions that the coach wants the pitcher in this example to perform. For example, calling out “BLUE 7” would correspond in FIG. 14 to a breaking ball in zone 2.

A similar example of the invention from FIG. 14 is shown in FIG. 15. This is an offensive band card where the numbers in the column are arranged in sequential order, but the commands and plays remain mixed. Component 46 displays the sequential numbers running down various columns. Component 47 shows another variation of the column headers. In FIG. 15, component 47, the columns are named after animals. There are many different ways to title these columns. These columns can also be colored different colors to make it easier to identify the limits of the various columns. Component 48 is the commands, actions, or plays that the coach desires for his players to perform. An example using FIG. 15 is where the coach calls out “Bird 6.” That command would direct a player on base to look at his band card, go to the “Bird” column, go down to number “6,” and understand his coach wants him to attempt to steal a base.

In further detail, still referring to the invention of FIG. 1 to FIG. 15, these band cards must be of sufficient size to read and decipher the sign, signal, pitch, or play called, while at the same time small enough to be worn or carried to be functional while playing the game of baseball. This is typically two to two and a half inches (2.5 inches) in height and five inches wide. However, these dimensions can change with the number of columns and rows and must be sufficiently large enough to remain legible by the player and coach. It must be sufficiently small enough to be attached to a wristband or article of clothing or hat or put in the player's pocket in order that they can participate in the sport. The band cards can be made on a variety of materials, which only must be substantial enough to make out the numbers, letters, and symbols, written, typed, or applied to the surface. These materials include, but are not limited to, copier or typing paper, construction paper, cardboard, or plastic. It is preferred that the band cards are laminated with a plastic covering such that the cards can be recycled over several games and protected from sweat and rain. The cards are normally made using a computer, a color printer, and a spreadsheet program. However, the band cards can also be made with a typewriter, pen, or pencil. The columns as shown have different background colors. The columns could be monochrome as well and use column headings to differentiate the different columns rather than by color.

The construction details of the band card apparatus and method invention as shown in FIG. 1 to FIG. 15 are each made of common typing or copier paper, but they of course can be made from any sufficiently solid material, such as cardboard or plastic. The band cards can be created using a computer and color printer using a spread sheet or word processing program to create the rows and columns in the chart. It is usually 2.5 inches by 5 inches so that it can be easily attached to the player's wrist or under the brim of his/her hat. However, this can vary by several inches and must be sufficiently large to display legible numbers, symbols, and colors. The band card must also be sufficiently small enough to be utilized by the players and coaches during the game of baseball itself. It can also be attached by other means. The band cards are usually made of standard copier or printer paper and then laminated. However, it can be made with just about any media capable of being printed or written on. Then, the card is inserted into inner and outer pockets in the wristband or attached to the underside of the baseball hat's brim so that the player can easily reference the card while still being involved in playing baseball (or softball). There is usually a flap on the wristband, with an inner pouch/window and another pouch/window in the flap itself. The flap is sewn along one side onto the wristband and then the other sides of the flap are secured with Velcro. The band cards can also be attached to the brim of the baseball hat using two complimentary pieces of Velcro, one on the back of the band card and the other on the underside of the hat's brim, so that cards can be easily exchanged every couple of innings without a whole lot of fuss.

The advantages of the present invention include, without limitation, the ability to effectively communicate signs and signals in a baseball environment. The defensive band cards, for signs, signals, and plays other than pitching, can be coordinated together such that the coach can make one signal that puts all of the players in their correct position and defensive plan. The pitching related band cards allow the coach to communicate a wide variety of instructions to his pitching team, or pitcher and catcher. This invention can be easily modified to fit the level and experience of the players or team in question. This invention will almost eliminate another team's ability to steal your signals and will greatly reduce the chances of a missed sign.

In broad embodiment, the present invention is a method and apparatus of any size and shape that allows the players to wear and possess the band cards will still playing the game of baseball. This invention could be used at all levels of baseball and softball, from little league to the big leagues (Major League Baseball). It will naturally need to be used in training and scrimmages in order to take full advantage of it in games. These band cards allow the players and coaches to be of the same mind in calling signs and signals during the game. The players and coaches and utilize these band cards in a variety of ways and as allowed by the rules of baseball. There is a variety of different ways the player can wear or carry the band cards. Players can wear the cards in a wristband that has a clear window allowing the player to see the band card while still being able to physically exert themselves during the game. They can also attach it to the underside of the brim on their hat. The players can wear the band cards in a clear container attached around their neck via a rope or chain. The players can stick the band cards in their pockets, socks, or inside their baseball gloves. The band cards are a system and method by which someone, usually the coach, can call in signs and signals to the players in such a manner that the opposing team can see or hear them and not be able to discern any patterns to predict what play has been called. The series of numbers can be replaced by words and the columns titled by numbers. It is a very flexible method by which a baseball coach can ensure his desired play is communicated to the various players. Since the players are referring to a set play, it virtually eliminates any confusion or miscommunication. It allows the coach to effectively communicate to his players the exact play or pitch that he wants, without worrying about miscommunication or interception by the opposing team. Likewise, it allows for more complicated play calling as there are code words and acronyms listed out according to a numeric code on a reference card worn by the players.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed:

1) A method of Baseball System for Signal Calling between a coach and player(s) for communicating a particular play, pitch, or position using a card which comprises:
a. Creating a matrix of symbols, letters and numbers on a cards corresponding to a play, position, or pitch, wherein the matrix is divided into colored columns and the rows having different data and corresponding to an offensive play, defensive play, or pitch;
with the offensive cards for hitting and base running having a series of columns, with a series of numbers from 0 to 999 corresponding to an action running down the column, with each line in the column having 1 to 3 numbers together; wherein the particular series of numbers does not repeat itself in that particular column;
with the defensive cards for getting the other team out having labels on the colored columns corresponding to the situation of the other team as far whether and where their base runners are located, and a series of numbers on each line in each column that correspond to a particular position or play for the next pitch and possible resulting action;
with the pitching cards having labels on the columns corresponding to the play or pitch the coach desires and a series of numbers and or symbols underneath the play or pitch;
b. displaying and recording the matrix on a card attached to the player and coach individually;
c. signaling a “hot” colomn which signifies the particular column a coach wants the players to refer to in signaling the play, position, or pitch;
d. signaling the plays from a coach to the player using said card, comprising a color or symbol and a series of numbers, the color can be the “hot” color or a “cold” color,
wherein the “cold” color signals to the players to ignore the numbers, letters, or symbols, until preceded by the “hot” color;
e. receiving the play called in by a coach to the player; and Baseball System and
f. interpreting the signal call using said card.

2) The claim in 1) further comprising a short count single number in each column next to a series of numbers as an alternative shortened way to identify the play, pitch or position a coach wants signaled to the player.

3) The claim in 1) further comprising alternating colored backgrounds for each column.

4) The claim in 1) further comprising a wristband for displaying said card.

5) The claim in 1) further comprising a means to display and attach said card to a baseball hat.

6) The claim in 1) further comprising a means to attach said card around a player's neck.

7) The claim in 1) further comprising a short count single number in each column next to a series of numbers as an alternative means to identify the play a coach wants signaled to the player.

8) Apparatus for performing baseball signal calling from a coach to the player(s) comprising:
a. means for storing signal calling data concerning either offense, defense, or pitching;
b. means for comparing and sorting the signals according to a system linking baseball plays or positioning to symbols and numbers;
c. means for selecting displayable information that has been sorted according to the system linking baseball plays or positioning to symbols or numbers;
d. means for displaying the selected displayable information;
e. means for calling in the system from a coach to the player.

9) Baseball System and Apparatus for signaling baseball plays comprising:
a. a matrix of symbols, letters, and numbers with the symbols and numbers identifying the rows and columns and a combination of number comprising the data in the matrix;
b. a means to attach and display the matrix on a baseball coach and player while allowing for athletic movement during a baseball game;
c. a wrist band means for processing the signals called in by a coach;
d. signal matrix means for encoding the signals in a fashion to prevent understanding by the opposing team or an antagonist;
e. means for communicating a combination of symbols, letters, or numbers from a coach to the player(s) which corresponds to a particular play, pitch, or position;
f. interpretation by the player of the matrix.
